(19) United States
(12) Patent Application Publication
(10) Pub. No.: US 2008/0018634 A1
(43) Pub. Date: Jan. 24, 2008

(54) LIQUID CRYSTAL DISPLAY DEVICE AND DRIVING METHOD THEREOF

(76) Inventors: Sang Jae Yeo, Hwaseong-si (KR); Hyung Guel Kim, Yongin-si (KR); Se Chun Oh, Seongnam-si (KR); Jong Won Moon, Yongin-si (KR)

Correspondence Address: F. CHAU & ASSOCIATES, LLC, 130 WOODBURY ROAD, WOODBURY, NY, 11797, US

(21) Appl. No.: 11/763,830

(22) Filed: Jun. 15, 2007

(30) Foreign Application Priority Data
Jul. 19, 2006 (KR) 2006-0067498

(51) Int. Cl. G09G 5/00

(52) U.S. Cl. 345/210; 345/208

(57) ABSTRACT

A liquid crystal display device and driving method thereof that are capable of generating positive and negative bias voltages the absolute values of which are symmetrical. The liquid crystal display device of the present invention includes a pulse generator for generating a pulse signal, a positive bias voltage generator for generating a positive bias voltage using (by rectifying) the pulse signal and a negative bias voltage generator for generating a negative bias voltage the absolute value of which is substantially symmetrical with the absolute value of the positive bias voltage. The pulse generator generates the pulse signal based on feedback of at least one of the positive and negative bias voltages.

### CROSS-REFERENCE TO RELATED PATENT APPLICATION

The present application claims priority, under 35 U.S.C. §119, of Korean Patent Application No. 2006-67498, filed on Jul. 19, 2006, the entire contents of which is incorporated by reference herein.

### BACKGROUND OF THE INVENTION

1. Field of the Invention

The present invention relates to a liquid crystal display (LCD) device and driving method of the liquid crystal display device. More particularly, the present invention relates to a liquid crystal display device and driving method thereof that are capable of generating positive and negative bias voltages having symmetrical absolute values.

2. Description of the Related Art

Generally, a LCD display module includes a LCD panel displaying images through a matrix (array) of liquid crystal cells (pixels), a backlight unit providing light in the LCD panel and a driving circuit driving the pixels of the LCD panel. The LCD panel displays an image by modulating light transmittance through liquid crystal according to voltages applied to the respective pixels.

The driving circuit is supplied with power by a DC-DC converter. The DC-DC converter generates a positive bias voltage, a negative bias voltage, a gate-on voltage and a gate-off voltage on using DC input voltages and transmits the voltages to respective circuit blocks.

The gamma voltage(s) and common voltage are generated by a Common/Gamma Voltage Generator (e.g., 104 in FIG. 1) from the negative bias voltage and the positive bias voltage. In order to optimize no the gamma voltages, the negative bias voltage and positive bias voltage should have substantially symmetrical characteristics. However, the conventional DC-DC converter generates positive and negative bias voltages having absolute values that are asymmetrical (e.g., not having equal absolute values relative to the ground voltage or gate-off voltage).

In the related art, conventional DC-DC converters including two (or more) magnetically coupled inductors (i.e., a transformer) can generate positive and negative bias voltages having absolute values that are symmetrical (e.g., having equal absolute values relative to the ground voltage), but the inclusion of such a transformer substantially increases component cost and increases the size of the DC-DC converter. Furthermore, adjusting the number (ratio) of coils in each of the two magnetically coupled inductors so that their output voltages are equal with sufficient precision may require a large number of coils and thus a larger resistive loss.

There is a need for a DC-DC converter capable of generating symmetrical positive and negative bias voltages using at most a single inductor (coil) without including a transformer (plural inductors).

### SUMMARY OF THE INVENTION

An aspect of the present invention provides an LCD device and a driving method thereof that are capable of providing optimized gamma voltages by generating positive and reserve bias voltages having symmetrical absolute values.

An aspect of the present invention provides a liquid crystal display device including a pulse generator configured to generate a pulse signal, a positive bias voltage generator configured to use the pulse signal to generate a positive bias voltage and a negative bias voltage generator configured to generate a negative bias voltage being substantially symmetrical with the value of the positive bias voltage, wherein the pulse generator generates the pulse signal in consideration of a rectification level of a rectifier which belongs to at least one of the positive and negative bias voltage generators.

Preferably, the pulse signal swings between a high voltage and a ground voltage.

Preferably, the positive bias voltage generator rectifies the pulse signal and includes a first rectifier including a plurality of diodes, and a capacitor.

Preferably, the negative bias voltage generator includes a charge-pumping capacitor and a diode inverting and reducing the pulse signal to output a second pulse signal and a second rectifier rectifying the second pulse signal including a single diode and a capacitor.

Preferably, the first rectifier includes a first diode and a second diode connected in series.

Preferably, the second rectifier includes a fourth diode dropping a low voltage and a high voltage of the second pulse signal to threshold voltage of the fourth diode.

Preferably, the liquid crystal display device further includes a gamma voltage generator using the positive and negative bias voltages to generate gamma voltages.

Preferably, the liquid crystal display device further includes a common voltage generator using the positive and negative bias voltages to generate a common voltage.

Another aspect of the present invention provides a method of driving a liquid crystal device. A method of driving a liquid crystal device of exemplary embodiment of the present invention includes generating a pulse signal, generating a positive bias voltage by rectifying the pulse signal (through a first rectifier) and generating a negative bias voltage, (the absolute value of which is substantially symmetrical of an absolute value of the positive bias voltage), by reducing and inverting the pulse signal and then rectifying the reduced, inverted pulse signal. The pulse signal may be reduced and inverted using a charge-pumping capacitor and a diode. Preferably, the pulse signal swings between a high voltage and a ground voltage.

Preferably, generating the positive bias voltage includes rectifying the pulse signal through a first rectifier comprising two diodes connected in series.

Preferably, generating the negative bias voltage includes generating a second pulse signal and inverting the pulse signal and rectifying the second pulse signal through a second rectifier comprising only a single diode.

Preferably, the method of driving the liquid crystal display device further includes generating gamma voltages using the positive and negative bias voltages.

Preferably, the method of driving the liquid crystal display device further includes generating a common voltage using the positive and negative bias voltages.

According to the above, the liquid crystal display device and driving method thereof generates the negative bias voltage and the positive bias voltage the absolute values of which are symmetrical such that an optimal gamma voltage may be generated from these negative and positive bias voltages.

Another aspect of the present invention provides a circuit for generating a first output voltage and a second output voltage from an input voltage, comprising: an inductor connected between the input voltage and a first node; a switch connected between the first node and a ground GND; a first rectifier, having a first forward voltage drop, connected between the first node and a second node, wherein the first output voltage is generated at the second node; a second capacitor connected between the second node and the ground; a charge-pump capacitor connected between the first node and a third node; a second rectifier, having a second forward voltage drop, connected between the third node and the ground; a third rectifier, having a third forward voltage drop, connected between the third node and a fourth node, wherein the second output voltage is generated at the fourth node.

The first output voltage and the input voltage are higher than the ground voltage (positive), and the second output voltage is lower than the ground voltage (negative), and the absolute values of the first output voltage and of a second output voltage, relative to the ground voltage, are approximately equal.

The first forward voltage drop of the first rectifier is equal to the sum of the second forward voltage drop plus the third forward voltage drop. The first forward voltage drop of the first rectifier is typically equal to twice the second forward voltage drop. The first forward voltage drop of the first rectifier typically comprises the forward voltage drop of two diodes connected in series, and the second forward voltage drop typically comprises the forward voltage drop of one diode. The diodes are preferably Schottky diodes.

Exemplary embodiments of the present invention are described in greater detail below with reference to the accompanying drawings. The same reference numbers will be used throughout the drawings to refer to the same or like parts. Detailed descriptions of well-known functions and structures incorporated herein are omitted to avoid obscuring the subject matter of the present invention.

While the present invention is susceptible of embodiment in many different forms, the examples of specific embodiments are shown in drawings with the understanding that the present disclosure is to be considered as an exemplification of the principles of the invention and is not intended to limit the invention to the specific embodiments illustrated.

### BRIEF DESCRIPTION OF THE DRAWINGS

The above and other features of the present invention will become apparent to persons skilled in the art by reference to the following detailed description when considered in conjunction with the accompanying drawings, wherein:

FIG. 1 is a block diagram of a LCD device according to an embodiment of the present invention;

FIG. 2 is a circuit diagram illustrating a DC-DC converter in the LCD device of FIG. 1, according to an embodiment of the present invention;

FIGS. 3a and FIG. 3b are graphs illustrating processes for generating a positive bias voltage using the DC-DC converter of FIG. 2;

FIGS. 4a and FIG. 4b are graphs illustrating processes generating a negative bias voltage using the DC-DC converter of FIG. 2;

FIG. 5 is a circuit diagram illustrating a gamma voltage generator 104 shown in FIG. 1; and

FIG. 6 is a circuit diagram illustrating a common voltage generator 104 shown in FIG. 1.

### DETAILED DESCRIPTION OF EXEMPLARY EMBODIMENTS

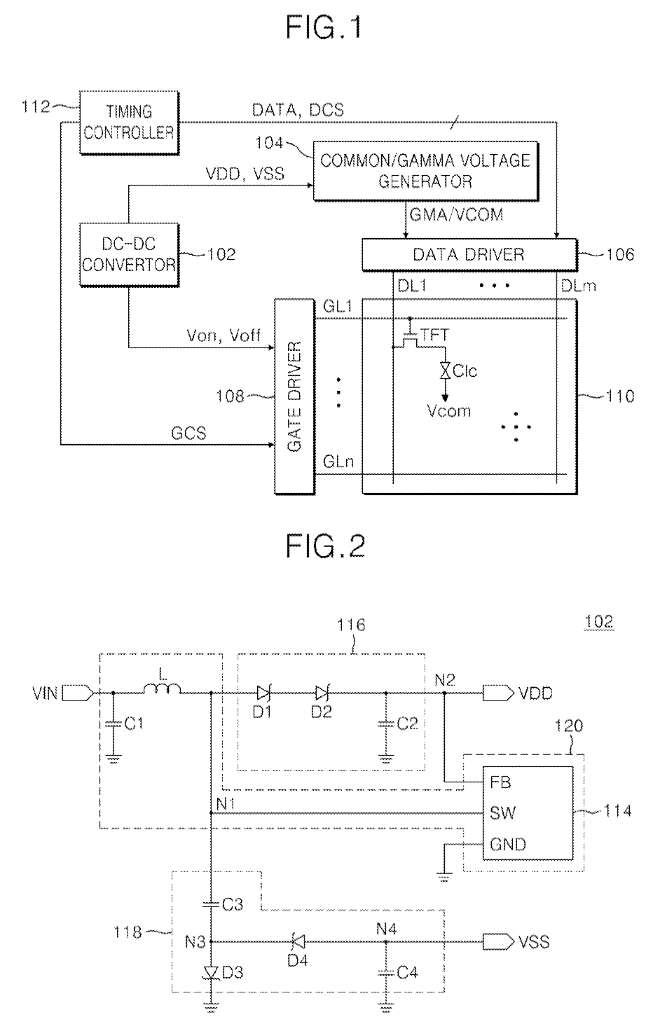

FIG. 1 is a block diagram of a LCD device including a DC-DC converter 102 according to an exemplary embodiment of the present invention.

The LCD device includes a LCD panel 110 (including an array of LCD pixels) for displaying images, a gate driver 108 and a data driver 106 driving the LCD panel 110, a timing controller 112 controlling the gate driver 108 and the data driver 106, a gamma/common voltage generator 104 generating and supplying gamma and common voltages to the data driver 106 and to the LCD panel 110, and a DC-DC converter 102 supplying various driving voltages to the circuit blocks.

The LCD panel 110 includes an array of liquid crystal cells (pixels) in the form of a matrix comprising thin film transistors (TFTs) formed at the intersections of gate lines and data lines extending from the gate driver 108 and the data driver 106 respectively for driving the respective liquid crystal cells. A thin film transistor is turned ON by a turn-on voltage (VON) supplied through a gate line and then a data (voltage) signal is supplied to the liquid crystal cell through the data line such that a voltage having a magnitude equal to the difference between a common voltage (VCOM) and the data signal is applied to across the liquid crystal cell. A thin film transistor is turned OFF by a turn-off voltage (VOFF).

The liquid crystal cells modulate the light transmittance through the liquid crystal according to the voltage to each cell (pixel) so as to display an image on the LCD panel.

The DC-DC converter 102 generates and outputs a positive bias voltage (VDD), a negative bias voltage (VSS), a turn-on voltage (VON), and a turn-off voltage (VOFF) from a single DC input voltage (VIN) (input to the DC-DC converter via the external connectors of the LCD device, not shown).

The positive and negative bias voltages (VDD and VSS) are supplied to the common/gamma voltage generator 104. The turn-on voltage (VON) and the turn-off voltage (VOFF) are supplied to the gate driver 108. The absolute values of the positive bias voltage (VDD) and of the negative bias voltage (VSS) are substantially symmetrical, relative to the ground voltage (GND, see FIG. 2). In other words, the absolute value of the positive bias voltage (VDD) is substantially equal to the absolute value of the negative bias voltage (VSS).

The timing controller 112 generates a plurality of control signals using synchronization signals (e.g., clock signals) input through the system (not shown) and supplies the control signals to the data driver 106. The timing controller 112 also arranges data signals input from external circuits (not shown) and transfers the arranged data signals to the data driver 106.

The gate driver 108 responds to the control signal GCS from the timing controller 112 so as to sequentially supply the turn-on voltage (VCOM) to the gate lines Gli (e.g., GL1 to GLn) in the rows of the LCD pixel array (in the LCD panel 110). And the gate driver supplies turn-off voltage (VOFF) to the gate lines, (e.g., when the turn-on voltages are not supplied to the gate lines).

The common/gamma voltage generator 104 generates a common voltage (VCOM) and a plurality of gamma voltages (GVA) having different (voltage) gradient levels dividing the analog driving voltage (AVDD). The plurality of gamma voltages (GMA) are supplied to the data driver 106 and the common voltage (VCOM) is supplied to the LCD panel 110 via the data driver 106.

The data driver 106 converts digital data signals (DATA) into analog voltages using the data control signal DCS from the timing controller 112 and the gamma voltages (GMA) and supplies the converted analog data voltages to the data lines DLi (e.g., DL1 to DLm) in the columns of the LCD pixel array (in the LCD panel 110).

FIG. 2 is a circuit diagram of the DC-DC converter 102 shown in FIG. 1.

Referring to FIG. 2, the DC-DC converter 102 includes a pulse generator 120 for generating pulse signals, a positive bias voltage generator 116 for generating the positive bias voltage (VDD) using a first pulse signal generated by the pulse generator 120, and a negative bias voltage generator 118 for generating the negative bias voltage (VSS) also using the first pulse signal.

The pulse generator 120 includes a pulse width modulation (PWM) integrated circuit (PWM IC 114), an inductor (L) (interposed between a switch terminal of the PWM IC 114 and a DC input voltage source (VIN)) and a first node (N1), and a first capacitor (C1) (interposed between the input voltage source (VIN) and a ground terminal).

The PWM IC 114 is driven by the DC input voltage (VIN) from the input voltage source so as to perform a pulse width modulation to generate a pulse signal and to output the width-modulated pulse signal.

The inductor (L) is connected to the switch terminal SW so as to store current supplied from the DC input voltage source when the switch SW is closed by the modulated pulse signal and supplies the stored current to the first node (N1) when the switch SW is opened.

The first capacitor (C1) stabilizes the input voltage (VIN) supplied to the inductor (L).

The positive bias voltage generator 116 includes a first diode (D1) and a second diode (D2) interposed between a first node (N1) and a second node (N2) (connected in series in the forward direction) and a second capacitor (C2) interposed between the second node (N2) and the ground terminal.

The first and second diodes (D1 and D2) rectify the current released from the pulse generator 120 and block the current from flowing in reserve direction. The first and second diodes (D1 and D2) are preferably Schottky Diodes capable of high speed operation.

The second capacitor (C2) stores and outputs the voltage input through the second diode (D2).

The negative bias voltage generator 118 includes a third capacitor (C3) (interposed between the first node (N1) and a third node (N3)), a third diode (D3) (the anode of which is connected to the third node (N3) and the cathode of which is connected to ground (GND)), a fourth diode (D4) (the cathode of which is connected to the third node (N3) and the no anode of which is connected to the to a fourth node (N4)), and a fourth capacitor (C4) (interposed between the fourth node (N4) and ground (GND).

The third and fourth diodes (D3 and D4) are preferably Schottky Diodes capable of high operating speed just like the first and second diodes (D1, D2).

The third capacitor (C3) stores the voltage output from the node 1 (N1) and outputs the stored voltage value. The fourth capacitor (C4) stores the voltage output from the fourth diode (D4) and outputs the stored voltage value.

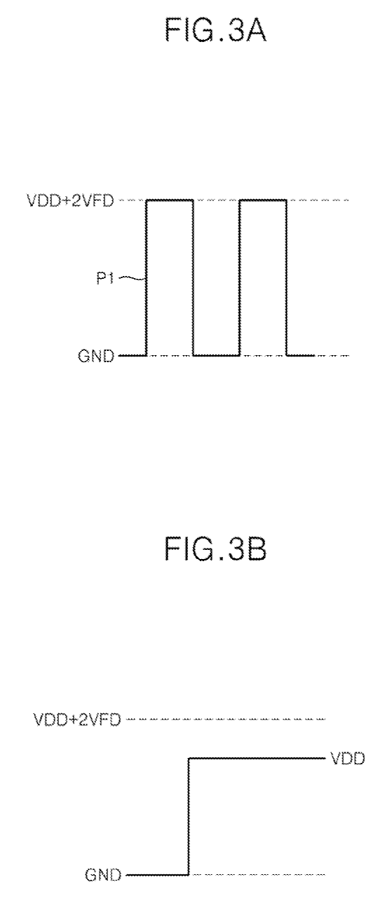

The operation of the above structured DC-DC converter 102 is described hereinafter with reference to FIGS. 2 and 3a. The PWM IC 114 is driven by the input voltage (VIN) supplied from the input voltage source so as to perform the pulse width modulation on the pulse signal generated inside and generates a modulated pulse signal.

The PWM IC (114) closes and opens the output switch SW connected to its output terminal using the modulated pulse signals for charging or discharging the current to and from the inductor (L) such that an amplified first pulse signal (P1) is generated at the first node (N1), as shown in FIG. 3a. The first pulse signal (P1) swings between the high voltage (VDD+2VFD) obtained by adding the positive bias voltage (VDD) to the sum of threshold voltages of the diodes (D1 and D2) arranged in the positive bias voltage generator 116 and the low voltage (ground voltage).

When the first pulse signal (P1) is supplied to the positive bias voltage generator 116, the first pulse signal (P1) is rectified by the first rectifier (the first and second diodes (D1 and D2) connected in series) and the second capacitor (C2) and then is output through the second node (N2) as the positive bias voltage (VDD). Particularly, when the high voltage (VDD+2VFD) of the first pulse signal (P1) is applied to the first node (N1), a forward bias voltage is applied to the first and second diodes such that the first and second diodes (D1 and D2) are turned ON. Accordingly, the positive bias voltage (VDD) dropped, from the high voltage (VDD+2VFD) of the first pulse signal (P1) by a voltage equal to the sum (2VFD) of the threshold voltages of the first and second diodes (D1 and D2) is applied to the second node (N2). The positive bias voltage (VDD) supplied to the second node (N2) is charged to the second capacitor (C2).

When a low voltage (GND) of the first pulse signal (P1) is applied to the first node (N1), a reverse bias voltage is applied to the first and second diodes (D1 and D2) such that the first and second diode (D1 and D2) are turned OFF. The second node (N2) maintains the positive bias voltage (VDD) during a predetermined time since the positive bias voltage (VDD) charged to the second capacitor (C2) is released through a resistance (load).

Meanwhile when the first pulse signal (P1) is supplied to the negative bias voltage generator 118, a portion of the first pulse signal (P1) (less the forward voltage drop through the third diode D3) is buffered (stored) by the third capacitor (C3) and then (when the first pulse signal is at ground GND) rectified through the second rectifier consisting of fourth diode (D4) and the fourth capacitor (C4). The rectified first pulse signal (P1) (less the forward voltage drops through the third and fourth diodes D3 and D4) is outputted to the fourth node (N4) as the negative bias voltage (VSS). In other words, when the first pulse signal (P1) at a high level is supplied to the first node (N1), a difference voltage ((−VDD−VFD) as much as difference between the threshold voltage (VFD) of the third diode (D3) and the high voltage (VDD+2VFD)) is charged across the third capacitor (C3). When the low voltage (GND) of the first pulse signal (P1) is applied to the first node (N1), a difference voltage (VFD) as much as difference between the threshold voltage (VFD) of the third diode (D3) and the low voltage of the first pulse signal (P1) is charged to the third capacitor.

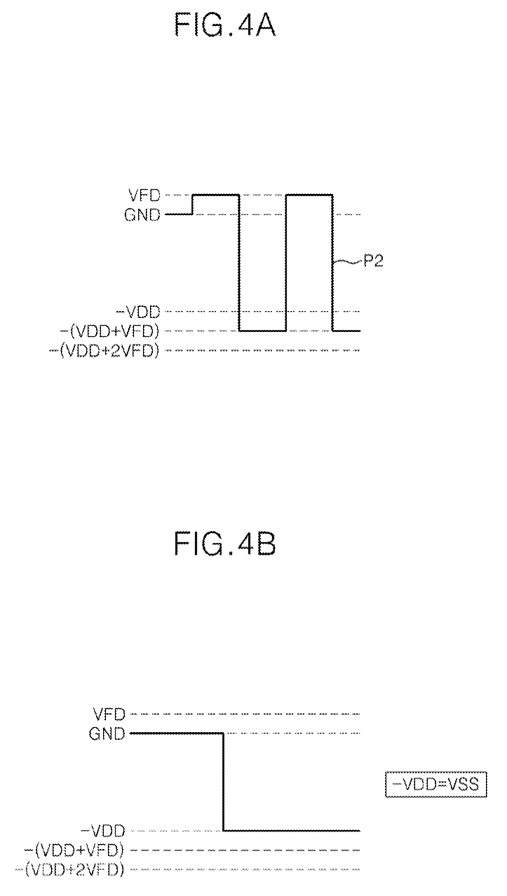

Similarly, a second pulse signal (P2) at node N3 swings between a high voltage and a low voltage. The high voltage of the second pulse signal (P2) is the voltage difference between the threshold voltage (VFD) of the third diode (D3) and the low voltage of the first pulse signal (P1). And the low voltage of the second pulse signal (P2) is the voltage difference between the threshold voltage (VFD) of the third diode (D3) and the high voltage (VDD+2VFD) of the first pulse signal (P1) as shown in FIG. 4a. The second pulse signal (P2) is applied to the third node (N3) and rectified by the fourth diode D4 (and stabilized by the fourth capacitor (C4)) so as to be converted into the negative bias voltage (VSS).

Particularly, when the high voltage (VFD) of the second pulse signal (P2) is supplied to the third node (N3), the reverse bias is applied to the fourth diode (D4) such that the fourth diode (D4) is turned OFF. Next, when the low voltage (−VDD−VFD) of the second pulse signal (P2) is applied to the third node (N3), a forward bias is applied to the fourth diode (D4) such that the fourth diode (D4) is turned ON. Accordingly, the negative bias voltage (VSS) raised as much as the threshold voltage level of the fourth diode (D4) from the low voltage (−VDD−VFD) of the second pulse signal (P2) is applied to the fourth node (N4).

At this time, the negative bias voltage (VSS) applied to the fourth node (N4) is charged to the fourth capacitor (C4). When the high voltage (VFD) of the second pulse signal (P2) is applied to the third node (N3), the reverse bias is applied to the fourth diode (D4) such that the fourth diode (D4) is turned OFF. At this time, the negative bias voltage (VSS) in the fourth capacitor (C4) is discharged (through a load) such that the fourth node (N4) maintains the negative bias voltage (VSS) during a predetermined time.

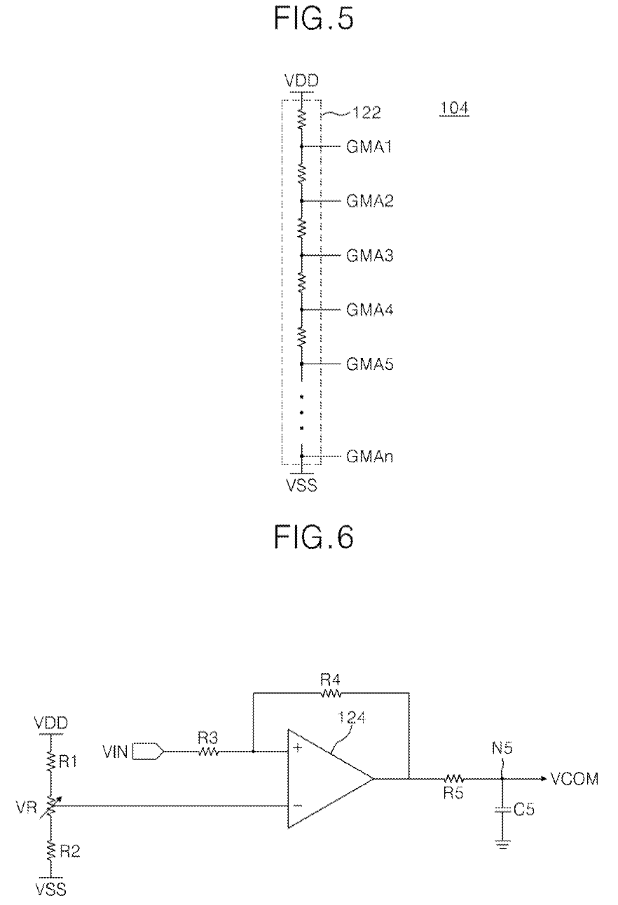

FIG. 5 is a circuit diagram illustrating the gamma voltage generator 104 connected to the DC-DC converter shown in FIG. 2.

Referring to FIG. 5, the gamma voltage generator 104 is implemented with a resistor string (122) comprising a plurality of resistors having different resistance values that are connected in series between the positive bias voltage (VDD) source and the negative bias voltage (VSS) source. The gamma voltage generator 104 generates different gamma voltages (GMA1 to GMAn) at voltage division nodes between the resistors.

FIG. 6 is a circuit diagram illustrating the common voltage generator 104 in the LCD device of FIG. 1.

Referring to FIG. 6, the common voltage generator includes an operational amplifier 124 a fifth resistor (R5) connected to an output terminal of the operational amplifier 124 and a fifth node (N5) connected to an output terminal of the common voltage generator 104 and a capacitor (C) connected between the output node (N5) and the ground terminal (GND).

At the non-inverting (+) input terminal of the operational amplifier 124, a voltage divided by a voltage division circuit (R3 and R4) is supplied. The voltage driven circuit includes a first resistor (R1), a variable resistor (VR), and a second resistor (R2). By changing the resistance of the variable resistor (VR), the common voltage (VCOM) is adjusted.

At an inverting terminal (−) of the operational amplifier 124, a direct current or an alternating current is supplied from an input voltage source (VIN). According to the input voltage (VIN), a voltage level and a polarity of the common voltage can be changed. The operational amplifier 124 amplifies the input voltage according to the amplification rate determined by the third resistor (R3) and the fourth resistor (R4) (the voltage division circuit).

The fifth resistor (R5) and the capacitor (C) constitutes an integrator, which smoothes (filters) the output voltage of the Operational Amplifier 124 so as to prevent variations of the common voltage (VCOM).

As described above, a liquid crystal display device and driving method thereof according to the present invention generates a pulse signal based on a rectification of the pulse signal used when generating a positive bias voltage and a negative bias voltage. Accordingly, the liquid crystal display device and driving method thereof according to the present invention generates the negative bias voltage and the positive bias voltage having absolute values that are symmetrical such that an optimal gamma voltage may be obtained based on these negative and positive bias voltages.

Although the exemplary embodiments of the present invention have been described above, it is understood that the present invention should not be limited to these exemplary embodiments and that various changes and modifications can be made by one ordinary skilled in the art within the spirit and scope of the present invention as hereinafter claimed.

What is claimed is:

1. A liquid crystal display device comprising:
a pulse generator for generating a pulse signal;
a positive output voltage generator including a first rectifier and for generating a positive output voltage using the pulse signal; and
a negative output voltage generator including a second rectifier and for generating a negative output voltage using the inductor and the switch,
wherein the absolute value of the negative output voltage is substantially symmetrical with the absolute value of the positive output voltage.

2. The liquid crystal display device of claim 1, wherein the pulse generator includes an inductor connected between an input voltage (VIN) Ground voltage (GND) through a switch.

3. The liquid crystal display device of claim 1, wherein the negative output voltage generator includes a charge-pump capacitor connected in series with a third rectifier, for inverting a portion of the pulse signal, and wherein the inverted portion of the pulse signal is rectified by a second rectifier.

4. The liquid crystal display device of claim 3, wherein the forward voltage drop of the first rectifier is approximately equal to the sum of the forward voltage drop of the second rectifier plus the voltage drop of the third rectifier.

5. The liquid crystal display device of claim 3, wherein the first rectifier contains N1 diodes connected in series, and the second rectifier contains N2 diodes connected in series and the third rectifier contains N3 diodes connected in series, wherein N1=N2+N3 and each of N1, N2 and N3 is a whole number.

6. The liquid crystal display device of claim 5, wherein N1 equals 2, N2 equals 1 and N3 equals 1.

7. The liquid crystal display device of claim 1, wherein the positive output voltage generator further comprises a second capacitor for stabilizing the positive output voltage.

8. The liquid crystal display device of claim 7, wherein the negative output voltage generator further includes a charge pump capacitor, and a fourth capacitor for stabilizing the negative output voltage.

9. The liquid crystal display device of claim 8, wherein the first rectifier includes a first diode and a second diode connected in series.

10. The liquid crystal display device of claim 9, wherein the second rectifier includes a fourth diode connected between a charge pump capacitor and the fourth capacitor.

11. The liquid crystal display device of claim 10, wherein the voltage at the node between the positive output voltage generator and the negative output voltage generator swings between a high voltage and the Ground GND voltage,
wherein the high voltage is equal to the sum of the forward voltage drops of the first and second diodes plus the positive output voltage.

12. The liquid crystal display device of claim 1, further comprising:
a gamma voltage generator using the positive and negative output voltages to generate gamma voltages; and
a common voltage generator using the positive and negative output voltages to generate a common voltage.

13. A method of driving a liquid crystal device, comprising:
generating a pulse signal;
generating a positive output voltage by rectifying the pulse signal; and
generating a negative output voltage,
wherein the absolute value of the negative output voltage is substantially symmetrical to the absolute value of the positive output voltage.

14. The method of claim 13, wherein the width of the pulse signal is based upon the positive output voltage.

15. The method of claim 13, wherein generating the positive bias voltage includes rectifying the pulse through a first rectifier having a first forward voltage drop.

16. The method of claim 15, wherein generating the negative output voltage includes:
generating a second pulse signal inverting the pulse signal; and
rectifying the second pulse signal through a second rectifier having a second forward voltage drop.

17. The method of claim 16, wherein generating the second pulse signal includes storing a portion of the voltage of the pulse signal in a charge-pumping capacitor, and inverting the stored portion of the pulse signal using the charge-pumping capacitor.

18. The method of claim 16, wherein the pulse signal is generated at a first node, and wherein generating the second pulse signal includes: charging a charge-pump capacitor connected between the first node and a third node with a voltage equal to the high voltage of the pulse signal minus the forward voltage drop of a diode, and then connecting the first node to ground GND, and
wherein the first forward voltage drop equals the sum of the forward voltage drop of the diode plus the second forward voltage drop.

19. The method of claim 16, wherein generating the pulse signal includes connecting the first end of an inductor to an input voltage, and alternately connecting and disconnecting the second end of the inductor to a ground voltage GND between the positive output voltage and the negative output voltage.

20. The method of claim 13, further comprising:
generating gamma voltages using the positive and negative output voltages; and
generating a common voltage using the positive and negative output voltages.

21. A circuit for generating a first output voltage and a second output voltage from an input voltage, comprising:
a pulse generator outputting a pulse signal to a first node;
a first rectifier, having a first forward voltage drop, connected between the first node and a second node, wherein the first output voltage is generated at the second node;
a charge-pump capacitor connected between the first node and a third node;
a second rectifier, having a second forward voltage drop, connected between the third node and the ground;
a third rectifier, having a third forward voltage drop, connected between the third node and a fourth node, wherein the second output voltage is generated at the fourth node.

22. The circuit of claim 21, further comprising:
a second capacitor connected between the second node and the ground, for stabilizing the second output voltage; and
a fourth capacitor connected between the third node and the ground, for stabilizing the second output voltage.

23. The circuit of claim 21, wherein the first output voltage and the input voltage are higher than the ground voltage, and the second output voltage is lower than the ground voltage, and the absolute values of the first output voltage and of a second output voltage, relative to the ground voltages are approximately equal.

24. The circuit of claim 21, wherein the first forward voltage drop of the first rectifier is equal to the sum of the second forward voltage drop plus the third forward voltage drop.

25. The circuit of claim 24, wherein the first forward voltage drop of the first rectifier is equal to twice the second forward voltage drop.

26. The circuit of claim 24, wherein the first forward voltage drop of the first rectifier comprises the forward voltage drop of two diodes connected in series, and the second forward voltage drop comprises the forward voltage drop of one diode.
